(19) United States
(12) Patent Application Publication
(10) Pub. No.: US 2007/0209868 A1
(43) Pub. Date: Sep. 13, 2007

(54) Safety harness with an integrated lanyard

(75) Inventors: Travis P. Betcher, Goodhue, MN (US); J. Thomas Wolner, Red Wing, MN (US)

Correspondence Address: IPLM GROUP, P.A., POST OFFICE BOX 18455, MINNEAPOLIS, MN, 55418, US

(73) Assignee: D B Industries, Inc.

(21) Appl. No.: 11/369,280

(22) Filed: Mar. 7, 2006

(51) Int. Cl. A62B 35/00

(52) U.S. Cl. 182/3

(57) ABSTRACT

A safety harness has a first strap, a second strap, and a third strap. The first strap and a second strap form shoulder straps. The third strap has a first end, a second end, and an intermediate portion between the first end and the second end. The first end is operatively connected to the first strap, the second end is operatively connected to the second strap, and the intermediate portion is releasably connected to the shoulder straps.

### FIELD OF THE INVENTION

The present invention relates to a safety harness.

### BACKGROUND OF THE INVENTION

Safety harnesses are commonly worn by people to assist in performing various functions such as work positioning, restraint, suspension, rescue, personnel riding, climbing, and fall protection. When used for rescue purposes, a Y-lanyard is commonly connected to D-rings operatively connected to the safety harness's shoulder straps to keep the person being rescued in an upright position and reduce the space needed to extract the person being rescued. An example of a safety harness suitable for rescue purposes is Model No. 1101254, a vest style rescue harness including shoulder D-rings, by D B Industries, Inc. of Red Wing, Minn. An example of a Y-lanyard suitable for rescue purposes is Model No. 1201460, a rescue Y-lanyard, by D B Industries, Inc. of Red Wing, Minn.

### SUMMARY OF THE INVENTION

One aspect of the invention provides a safety harness having a first strap, a second strap, and a third strap. The first strap and a second strap form shoulder straps. The third strap has a first end, a second end, and an intermediate portion between the first end and the second end. The first end is operatively connected to the first strap, the second end is operatively connected to the second strap, and the intermediate portion is releasably connected to the shoulder straps.

Another aspect of the invention provides a safety harness having criss-crossing shoulder straps and a lanyard strap. The criss-crossing shoulder straps extend in divergent fashion from a juncture of the criss-crossing shoulder straps. The lanyard strap includes a first end, a second end, and an intermediate portion between the first end and the second end. The lanyard strap forms a V-shape corresponding with the divergent fashion of the criss-crossing shoulder straps proximate the juncture. The first end is operatively connected to one shoulder strap and the second end is operatively connected to another shoulder strap. The intermediate portion extends from proximate the juncture to each of the ends along the shoulder straps, and the intermediate portion is releasably connectable to the shoulder straps.

Another aspect of the invention provides a method of rescuing a person donning a safety harness including a first shoulder strap, a second shoulder strap, and a lanyard strap. The lanyard strap has a first end slidably connected to the first shoulder strap and a second end slidably connected to the second shoulder strap. The lanyard is releasably connected to the first and second shoulder straps. The lanyard strap is released from the first and second shoulder straps, and a hook is connected to the lanyard strap. The lanyard strap is pulled upward with the hook, and the lanyard strap slides along the first and second shoulder straps toward proximate a top of the person's shoulders to hold the person in an upright orientation.

### BRIEF DESCRIPTION OF THE DRAWINGS

FIG. 1 is a rear perspective view of a safety harness with an integrated lanyard;

FIG. 2 is a front view of the integrated lanyard shown in FIG. 1 partially assembled;

FIG. 3 is a front view of the integrated lanyard shown in FIG. 1 assembled; and

FIG. 4 is a rear perspective view of a portion of another embodiment safety harness with an integrated lanyard.

### DETAILED DESCRIPTION OF A PREFERRED EMBODIMENTS

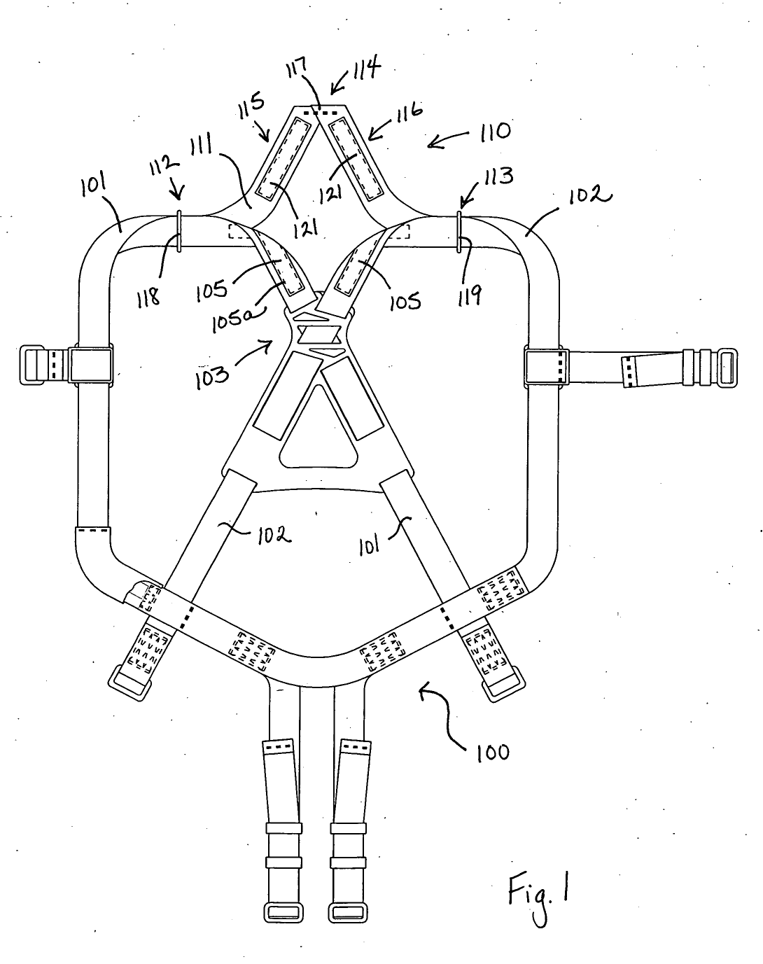

The present invention is a safety harness with an integrated lanyard to be used during rescue of the person donning the safety harness. A safety harness constructed according to the principles of the present invention is designated by the numeral 100 in FIG. 1, and another embodiment safety harness constructed according to the principles of the present invention is designated by the numeral 200 in FIG. 4.

The safety harness 100 includes a dorsal pad assembly 103 connecting criss-crossing shoulder straps 101 and 102 extending in divergent fashion from a juncture of the criss-crossing shoulder straps 101 and 102. This is shown in FIG. 1. An example of such a safety harness is disclosed in U.S. Pat. No. 6,253,874, which is incorporated by reference herein. Although safety harness 100 is shown, it is recognized that other suitable safety harnesses may be used. A loop material 105 is connected by stitching 105a to the exterior surface of the first shoulder strap 101 and the second shoulder strap 102 proximate the dorsal pad assembly 103 and extending upward toward where the person's shoulders would be when donning the safety harness 100.

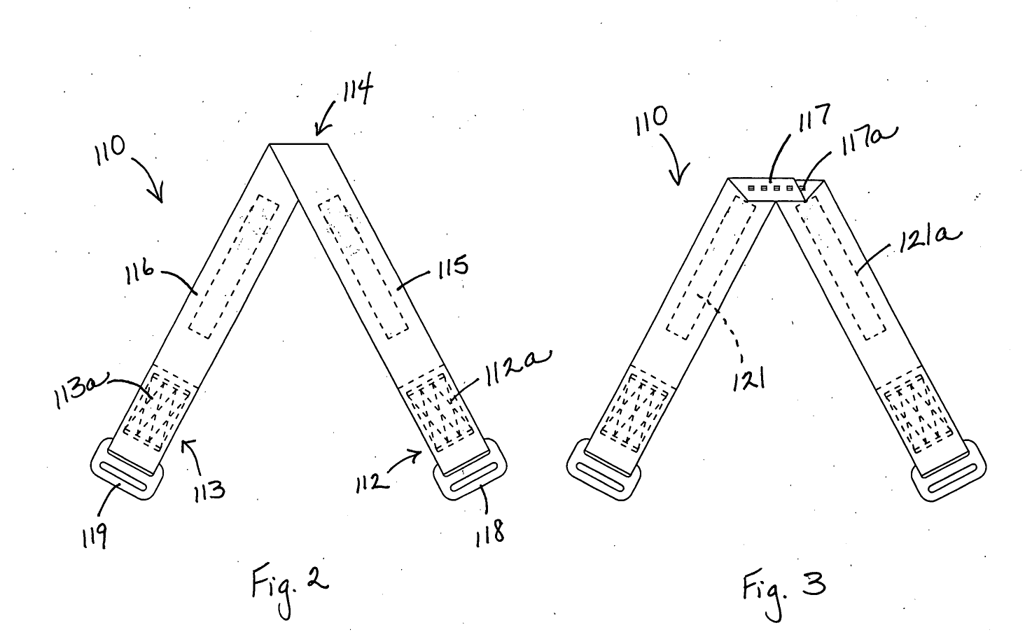

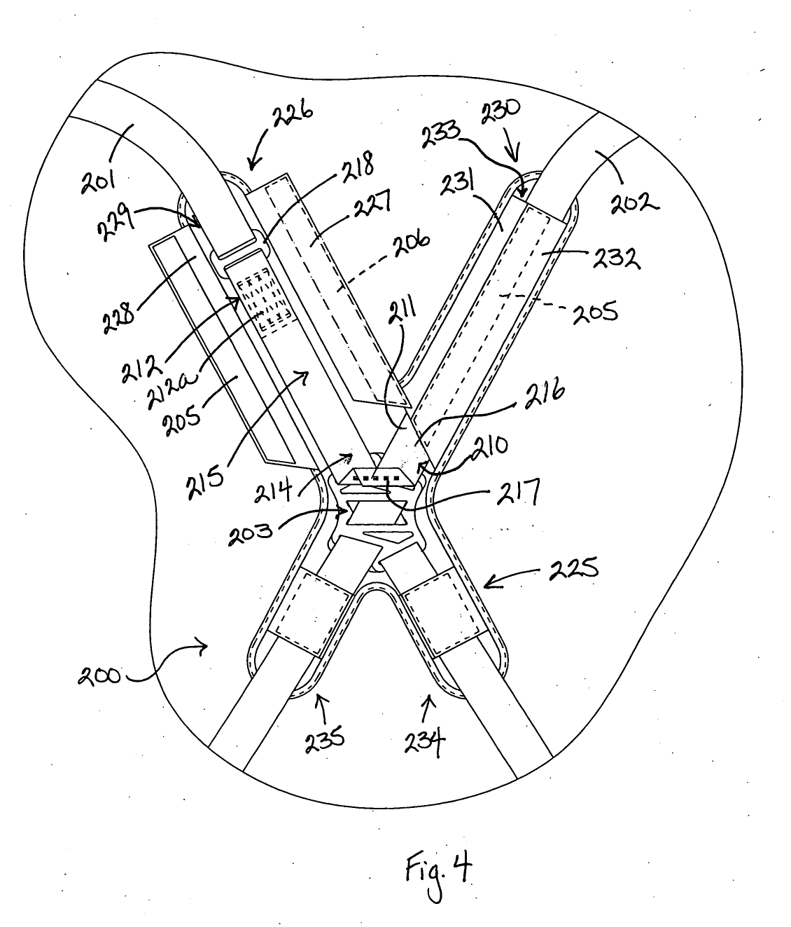

A lanyard 110 includes a strap 111 having a first end 112, a second end 113, and a middle portion 114 therebetween. The strap 111 is preferably an elongate piece of webbing. As shown in FIG. 2, the strap 111 is folded once proximate the middle portion 114 so that the ends 112 and 113 are a desired distance apart to form a V-shape corresponding with a V-shape formed by the shoulder straps 101 and 102 proximate above the dorsal pad assembly 103. As shown in FIG. 3, the point of the “V” is folded, preferably twice, and fastened proximate the fold with stitching 117a to form a connecting portion 117. Between the connecting portion 117 and the first end 112 is a first intermediate portion 115, and between the connecting portion 117 and the second end 113 is a second intermediate portion 116. A hook material 121 is connected by stitching 121a onto the interior surface of each of the intermediate portions 115 and 116 corresponding with the loop material 105 of the shoulder straps 101 and 102.

The first end 112 of the strap 111 is operatively connected to a first buckle 118, and the second end 113 of the strap is operatively connected to a second buckle 119. Each of the buckles 118 and 119 is preferably a three bar buckle having two slots. The first end 112 of the strap 111 is inserted through one slot of the first buckle 118 and fastened onto itself with stitching 112a to secure the strap 111 to the first buckle 118. The first shoulder strap 101 is inserted through the second slot of the first buckle 118, which slidably operatively connects the first end 112 to the shoulder strap 101. The second end 113 of the strap 111 is inserted through one slot of the second buckle 119 and fastened onto itself with stitching 113a to secure the strap 111 to the second buckle 119. The second shoulder strap 102 is inserted through the second slot of the second buckle 119, which slidably operatively connects the second end 113 to the shoulder strap 102. The hook material 121 on the lanyard 110 mates with the loop material 105 on the safety harness 100 to releasably secure the lanyard 110 to the safety harness 100 when the lanyard 110 is not in use. This prevents the lanyard 110 from catching on something or otherwise interfering with the performance of tasks.

If the person donning the safety harness 100 must be rescued, the connecting portion 117 of the lanyard 110 may be grabbed and pulled upward to release the hook material 121 from the loop material 105, and the lanyard 110 is ready for use. The connecting portion 117 of the lanyard 110 is the portion to which a connector such as a hook is connected to rescue the person. When the lanyard 110 is pulled upward from proximate the connecting portion 117, the ends 112 and 113 of the lanyard 110 slide along the shoulder straps 101 and 102 of the safety harness 100 to proximate the tops of the person's shoulders so that the person is held in an upward position during rescue. Alternatively, if the lanyard 110 cannot be released from the safety harness 100 prior to connecting the connector to the connecting portion 117, the connector can be connected to the connecting portion 117 and the lanyard 110 will be released from the safety harness 100 as the connector and the connecting portion 117 move upward to rescue the person.

The safety harness 200 includes a dorsal pad assembly 203 connecting criss-crossing shoulder straps 201 and 202 extending in divergent fashion from a juncture of the crisscrossing shoulder straps 201 and 202. A removable padding 225 is generally X-shaped to correspond with the crisscrossing shoulder straps 201 and 202. The removable padding 225 includes a first portion 226 extending upward proximate the dorsal pad assembly 203 and the first shoulder strap 201, a second portion 230 extending upward proximate the dorsal pad assembly 203 and the second shoulder strap 202, a third portion 234 extending downward proximate the dorsal pad assembly 203 and the first shoulder strap 201, and a fourth portion 235 extending downward proximate the dorsal pad assembly 203 and the second shoulder strap 202.

A first flap 227 and a second flap 228 are connected to opposing sides of the first portion 226 and extend toward and overlap a portion of one another. The first flap 227 includes a hook material 206 that mates with a loop material 205 on the second flap 228 to secure the overlapping portions of the flaps 227 and 228 together to form a channel 229 between the first portion 226 and the flaps 227 and 228. A third flap 231 and a fourth flap 232 are connected to opposing sides of the second portion 230 and extend toward and overlap a portion of one another. The third flap 231 includes a hook material that mates with a loop material 205 on the fourth flap 232 to secure the overlapping portions of the flaps 231 and 232 together to form a channel 233 between the second portion 230 and the flaps 231 and 232. The third portion 234 and the fourth portion 235 are similarly constructed. This is shown in FIG. 4. The flaps allow the portions to be releasably connected to the respective shoulder straps, and the shoulder straps 201 and 202 are slidable within the channels. An example of such a safety harness and a removable padding is disclosed in U.S. Pat. No. 6,971,476, which is incorporated by reference herein. Although safety harness 200 is shown, it is recognized that other suitable safety harnesses may be used with such a removable padding.

The lanyard 210 is constructed similarly to lanyard 110. The lanyard 210 includes a strap 211 having a first end 212, a second end (not shown), and a middle portion 214 therebetween. The strap 211 is preferably an elongate piece of webbing. The strap 211 is folded once proximate the middle portion 214 so that the ends are a desired distance apart to form a V-shape corresponding with a V-shape formed by the shoulder straps 201 and 202 proximate above the dorsal pad assembly 203. The point of the “V” is folded, preferably twice, and fastened proximate the fold with stitching to form a connecting portion 217. Between the connecting portion 217 and the first end 212 is a first intermediate portion 215, and between the connecting portion 217 and the second end (not shown) is a second intermediate portion 216.

The first end 212 of the strap 211 is operatively connected to a first buckle 218, and the second end of the strap is operatively connected to a second buckle (not shown). Each of the buckles is preferably a three bar buckle having two slots. The first end 212 of the strap 211 is inserted through one slot of the first buckle 218 and fastened onto itself with stitching 212a to secure the strap 211 to the first buckle 218. The first shoulder strap 201 is inserted through the second slot of the first buckle 218, which slidably operatively connects the first end 212 to the shoulder strap 201. The second end of the strap 211 and the second shoulder strap 202 are similarly connected to the second buckle.

The lanyard 210 may be releasably secured to the safety harness 200 when not in use to prevent the lanyard 210 from catching on something or otherwise interfering with the performance of tasks. The flaps 227 and 228 are opened to allow access to the channel 229, the first intermediate portion 215 and the first end 212 are placed proximate the first shoulder strap 201, and the flaps 227 and 228 are overlapped so that the loop material 205 and the hook material 206 releasably secure the flaps 227 and 228 together thereby securing the first intermediate portion 215 to the safety harness 200. Similarly, the flaps 231 and 232 are opened to allow access to the channel 233, the second intermediate portion 216 and the second end are placed proximate the second shoulder strap 202, and the flaps 231 and 232 are overlapped so that the loop material 205 and the hook material 206 releasably secure the flaps 231 and 232 together thereby securing the second intermediate portion 216 to the safety harness 200.

If the person donning the safety harness 200 must be rescued, the flaps of the first portion 226 and the second portion 230 are released thereby disconnecting the lanyard 210 and the shoulder straps 201 and 202 from the removable padding 225. The connecting portion 217 of the lanyard 210 is then more readily accessible. The connecting portion 217 is the portion to which a connector such as a hook is connected to rescue the person. When the lanyard 210 is pulled upward from proximate the connecting portion 217, the ends of the lanyard 210 slide along the shoulder straps 201 and 202 of the safety harness 200 to proximate the tops of the person's shoulders so that the person is held in an upward position during rescue.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A safety harness, comprising:
a) a first strap and a second strap forming shoulder straps; and
b) a third strap having a first end, a second end, and an intermediate portion between the first end and the second end, the first end being operatively connected to the first strap, the second end being operatively connected to the second strap, and the intermediate portion being releasably connected to the shoulder straps.

2. The safety harness of claim 1, wherein the first strap and the second strap criss-cross at a juncture and extend in divergent fashion from the juncture, the third strap having a V-shape conforming with the first strap and the second strap proximate the juncture.

3. The safety harness of claim 1, further comprising a first mating member connected to the first strap and the second strap and a second mating member connected to the third strap, the first mating member and the second mating member being releasably connectable thereby releasably connecting the first strap and the second strap to the third strap.

4. The safety harness of claim 1, further comprising a removable padding having an open position and a closed position, the open position allowing the straps to be received by and removed from the removable padding, the closed position engaging the straps.

5. The safety harness of claim 1, wherein the intermediate portion includes a connecting portion configured and arranged to be connected to a hook.

6. The safety harness of claim 5, wherein the third strap is a piece of webbing folded over itself to form a V-shape having ends and a point portion, the ends of the V-shape being the first end and the second end, the point portion of the V-shape being the connecting portion, the V-shape corresponding with the shoulder straps.

7. The safety harness of claim 1, further comprising a first buckle interconnecting the first strap and the first end and a second buckle interconnecting the second strap and the second end.

8. The safety harness of claim 1, wherein the first end is slidably connected to the first strap and the second end is slidably connected to the second strap.

9. A safety harness, comprising:
a) criss-crossing shoulder straps extending in divergent fashion from a juncture of the criss-crossing shoulder straps; and
b) a lanyard strap including a first end, a second end, and an intermediate portion between the first end and the second end, the lanyard strap forming a V-shape corresponding with the divergent fashion of the criss-crossing shoulder straps proximate the juncture, the first end being operatively connected to one shoulder strap and the second end being operatively connected to another shoulder strap, the intermediate portion extending from proximate the juncture to each of the ends along the shoulder straps, the intermediate portion being releasably connectable to the shoulder straps.

10. The safety harness of claim 9, wherein the lanyard strap is made of webbing.

11. The safety harness of claim 9, wherein the lanyard strap is folded over itself proximate the intermediate portion to form the V-shape.

12. The safety harness of claim 9, further comprising further comprising a first mating member connected to the shoulder straps and a second mating member connected to the lanyard strap, the first mating member and the second mating member being releasably connectable thereby releasably connecting the shoulder straps to the lanyard strap.

13. The safety harness of claim 9, further comprising a removable padding having an open position and a closed position, the open position allowing the straps to be received by and removed from the removable padding, the closed position engaging the straps.

14. The safety harness of claim 9, wherein the first end is slidably connected to one shoulder strap and the second end is slidably connected to another shoulder strap.

15. A method of rescuing a person donning a safety harness including a first shoulder strap, a second shoulder strap, and a lanyard strap, the lanyard strap having a first end slidably connected to the first shoulder strap and a second end slidably connected to the second shoulder strap, the lanyard being releasably connected to the first and second shoulder straps, comprising:
a) releasing the lanyard strap from the first and second shoulder straps;
b) connecting a hook to the lanyard strap; and
c) pulling upward on the lanyard strap with the hook, the lanyard strap sliding along the first and second shoulder straps toward proximate a top of the person's shoulders to hold the person in an upright orientation.

16. The method of claim 15, further comprising placing a removable padding in an open position to release the lanyard strap and the shoulder straps from the removable padding, the removable padding releasably connecting the shoulder straps and the lanyard strap.
